(19) United States
(12) Patent Application Publication
(10) Pub. No.: US 2009/0271603 A1
(43) Pub. Date: Oct. 29, 2009

(54) EMBEDDED SYSTEM AND STARTUP METHOD THEREOF

(75) Inventor: HUNG-JUNG WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/127,934

(22) Filed: May 28, 2008

(30) Foreign Application Priority Data
Apr. 28, 2008 (CN) 200810301385.X

(51) Int. Cl. G06F 15/177

(52) U.S. Cl. 713/2

(57) ABSTRACT

An embedded system includes a controller and a memory. The memory includes a primary firmware module, a backup firmware module, and a boot loader module. The primary firmware module has a primary firmware id_address. The backup firmware module has a backup firmware id_address. The boot loader module has a boot loader id_address. The controller is capable of activating the boot loader module to check status of the primary firmware module via the primary firmware id_address. Upon the condition that status of the primary firmware module is ok, the controller is capable of activating the primary firmware module. Upon the condition that status of the primary firmware module is not ok, the controller is capable of activating the backup firmware module via the backup firmware id_address.

### BACKGROUND

1. Field of the Invention

The present invention relates to an embedded system and startup method thereof.

2. Description of Related Art

In computing, firmware is a computer program that is embedded in a hardware device, for example a microcontroller. It can also be provided on flash ROMs or as a binary image file that can be loaded into existing hardware by a user. Firmware has evolved to mean the programmable content of a hardware device, which can consist of machine language instructions for a processor, or configuration settings for a fixed-function device, gate array or programmable logic device.

But if there is a problem with activating the firmware, the system cannot work. Upon this condition, users have to ask for professional help to replace or repair the firmware.

### SUMMARY

An exemplary embedded system includes a controller and a memory. The memory includes a primary firmware module, a backup firmware module, and a boot loader module. The primary firmware module has a primary firmware id_address. The backup firmware module has a backup firmware id_address. The boot loader module has a boot loader id_address. The controller is capable of activating the boot loader module to check status of the primary firmware module via the primary firmware id_address when a startup is initialized. Upon the condition that status of the primary firmware module is ok, the controller is capable of activating the primary firmware module. Upon the condition that status of the primary firmware module is not ok, the controller is capable of activating the backup firmware module via the backup firmware id_address.

Other advantages and novel features will become more apparent from the following detailed description when taken in conjunction with the accompanying drawings, in which:

### BRIEF DESCRIPTION OF THE DRAWINGS

FIG. 1 is a block diagram of one embodiment of a memory of an embedded system in accordance with the present invention; and

FIG. 2 is a flow chart of a startup method of the embedded system of FIG. 1.

### DETAILED DESCRIPTION

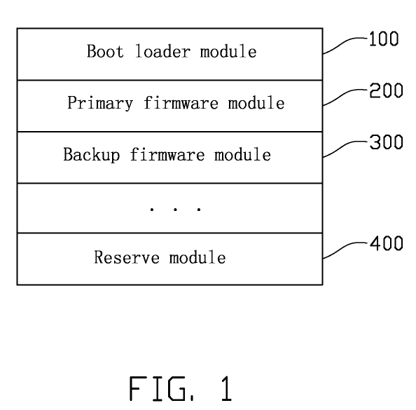

Referring to FIG. 1, an embedded system in accordance with an embodiment of the present invention includes a controller, such as a central processing unit (CPU), and a memory, such as a flash memory. The memory includes a boot loader module 100, a primary firmware module 200, a backup firmware module 300, and a reserve module 400. The boot loader module 100 includes a boot loader id_address. The primary firmware module 200 includes a primary firmware id_address. The backup firmware module 300 includes a backup firmware id_address. The controller is capable selectively activating the primary firmware module 200 or the backup firmware module 300 via a jumper instruction and the primary firmware id_address or the backup firmware id_address.

The boot loader module 100 is configured to check status of the primary firmware module 200 via checksum arithmetic. For example, the boot loader module 100 adds all the bits in the primary firmware module 200 to check status of the primary module 200. If the sum of all the bits is 0, status of the primary firmware module 200 is ok. Otherwise, if the sum of all the bits is not 0, status of the primary firmware module 200 is not ok. In other embodiments, the boot loader module 100 can check status of the primary firmware module 200 via other methods similar to the above. There can be more than one backup firmware module 300 according to need, and each of the backup firmware modules should include an id_address. The controller can activate the backup firmware module via its id_address. The reserve module 400 is configured to extend the backup firmware module 300. There can be more than one reserve module 400 according to need.

When the controller starts, it activates the boot loader module 100 to check status of the primary firmware module 200. In this embodiment, the id_address of the boot loader module 100 is located in the boot area, which is named “entry point” of the controller.

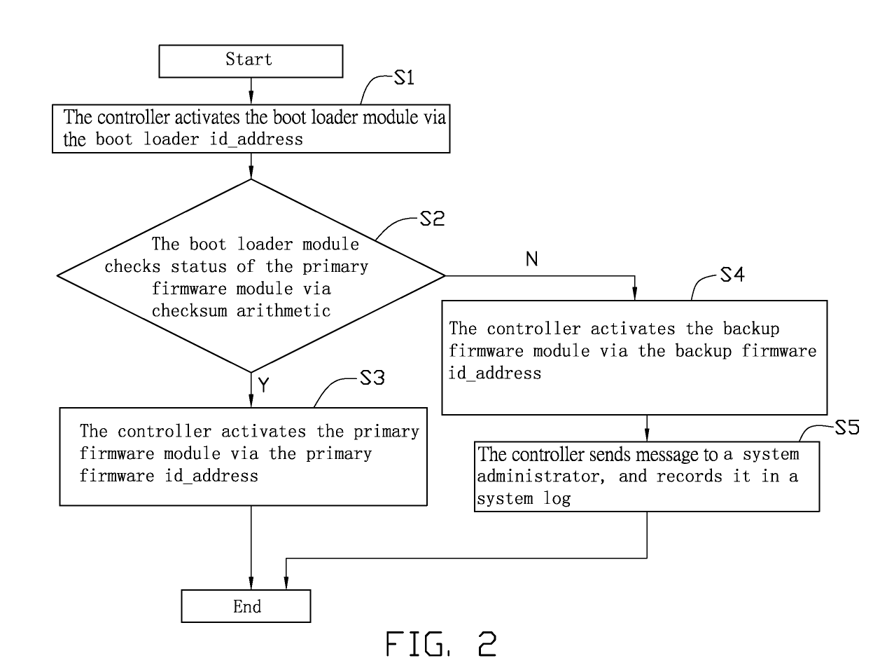

Referring to FIG. 2, the startup method of the embedded system in accordance with an embodiment of the present invention includes the following steps:

Step S1: the controller activates the boot loader module 100 via the id_address thereof.

Step S2: the boot loader module 100 checks status of the primary firmware module 200 via the checksum arithmetic. If the status is OK go to step S3, otherwise go to step S4.

Step S3: the controller activates the primary firmware module 200 via the id_address thereof to start the system. Then step S5 is next.

Step S4: the controller activates the backup firmware module 300 via the id_address thereof to start the system. Then step S5 is next.

Step S5: (in other embodiments this step may be omitted) the controller sends a message to the system administrator, and records it in the system log.

In other embodiments, in Step S2, the boot loader module 100 can check status of the primary firmware module 200 via some other known check method, and Step S5 can be omitted. When status of the primary firmware module 200 is not ok, the system can start with the backup firmware module 300 thus avoiding the need for professional help.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternately embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An embedded system comprising:
a controller; and
a memory comprising:
a primary firmware module comprising a primary firmware id_address,
a backup firmware module comprising a backup firmware id_address; and
a boot loader module comprising a boot loader id_address, wherein the controller is capable of activating the boot loader module to check status of the primary firmware module via the boot loader id_address when a startup is initialized; upon the condition that status of the primary firmware module is ok, the controller is capable of activating the primary firmware module; upon the condition that status of the primary firmware module is not ok, the controller is capable of activating the backup firmware module via the backup firmware id_address.

2. The embedded system as claimed in claim 1, wherein the boot loader module is capable of checking the status of the primary firmware module via checksum arithmetic.

3. The embedded system as claimed in claim 1, wherein the memory further comprises a reserve module capable of extending the backup firmware module.

4. The embedded system as claimed in claim 1, wherein the memory further comprises a plurality of backup firmware modules, and wherein the controller is capable of selectively activating each of the plurality of backup firmware modules.

5. A startup method comprising:
providing the system of claim 1;
the controller activating the boot loader module when the embedded system starts;
the boot loader module checking status of the primary firmware module;
upon the condition that status of the primary firmware module is ok, the controller activates the primary firmware module via the primary firmware id_address to start the embedded system; and
upon the condition that status of the primary firmware module is not ok, the controller activates the backup firmware module via the backup firmware id_address to start the embedded system.

6. The startup method as claimed in claim 5, further comprising:
after the controller activates the backup firmware module, the controller sends messages to a system administrator, and records it in a system log.

7. The startup method as claimed in claim 5, wherein the boot loader module checks status of the primary firmware module via checksum arithmetic, upon the condition that sum of all bits in the primary firmware module is 0, status of the primary firmware module is deemed ok; upon the condition that sum of all bits in the primary firmware module is not 0, status of the primary firmware module is deemed not ok.

8. An embedded system comprising:
a memory comprising:
a primary firmware module;
a backup firmware module; and
a boot loader module capable of checking status of the primary firmware module; and
a controller capable of selectively activating the primary firmware module or the backup firmware module according to status of the primary firmware module.

9. The embedded system as claimed in claim 8, wherein the primary firmware module comprises a primary firmware id_address, the backup firmware module comprises a backup firmware id_address, the boot loader module comprises a boot loader id_address,:
wherein the controller is capable of activating the primary firmware module, the backup firmware module, and the boot loader module respectively according to the primary firmware id_address, the backup firmware id_address, and the boot loader id_address.

10. The embedded system as claimed in claim 8, wherein the boot loader is capable of checking the status of the primary firmware module via checksum arithmetic.

11. The embedded system as claimed in claim 8, wherein the memory further comprises a reserve module capable of extending the backup firmware module.

12. The embedded system as claimed in claim 8, wherein the memory further comprises a plurality of backup firmware modules, and wherein the controller is capable of selectively activating each of the plurality of backup firmware modules.
